(19) United States
(12) Patent Application Publication
(10) Pub. No.: US 2006/0138805 A1
(43) Pub. Date: Jun. 29, 2006

(54) Free-shaped floor surface vehicle

(76) Inventors: Toshihiro Fukumoto, Tokyo (JP); Yousuke Fukumoto, Tokyo (JP); Keiko Ebato, Tokyo (JP)

Correspondence Address: BROWDY AND NEIMARK, P.L.L.C.;624 NINTH STREET, NW, SUITE 300, WASHINGTON, DC, 20001-5303, US

(21) Appl. No.: 10/541,122

(22) PCT Filed: Jan. 23, 2004
(86) PCT No.: PCT/JP04/00624

§ 371 Date: Dec. 15, 2005

(30) Foreign Application Priority Data
Jan. 23, 2003 (JP) 2003-014280

(51) Int. Cl. B62D 25/00

(52) U.S. Cl. 296/193.01

(57) ABSTRACT

[PROBLEMS] To more increase the capability of a vehicle despite the fact that mankind cannot catch up an increase in performance of the vehicle by forming the vehicle to give less damage to persons in the event of the accident of the vehicle and to minimize emission from the vehicle. [MEANS FOR SOLVING PROBLEMS] The safety of occupants in the vehicle depends upon the degree of collapse of the vehicle at the time of collision. The non-pollution of the vehicle depends upon the speed to the design change of the vehicle to alter the specifications based on the latest technologies. For this purpose, a carriage allowing the easy design change must be developed. A structure allowing the easy change of the carriage portion of the vehicle has been developed.

### TECHNICAL FIELD

This invention drastically improves the structure of the frame that becomes the truck of the vehicle, and changes the vehicle etc. to a flexible structure drastically. It is a technology that achieves a safe, flexible working condition. Technology therefore that makes it correspond by changing the composition of the division type frame that can correspond to the variable structure and the size into the truck structure.

The cause of the traffic accident is mostly the lower performances of the straight advancement. As the cause, it is that vehicles cannot be controlled in the direction by the steering wheel with slipping, the stone, and the falling object etc. and vehicles run to the wrong direction. It is technologies that greatly reduce the danger.

It is a technology that the convenience of the operation of the crew's getting on and off, the piling up and unloading the freight, and the work structure in the upper part improves greatly by freely changing the floor position of the vehicle.

The shock reduction at the collision is desirable by the vehicle being broken as buffer to reduce the damage of the crew. However, the way of thinking from the viewpoint that breaking the vehicle is little because it cannot help but take strength of the truck important from the present viewpoint of the design. In this technology, the main portion is technology in the respect that can correspond flexibly since it connects with the joint that can adjust the angle.

Since the vehicle uses many small sum diameter tires, safety in operation is very steady. The technology which controls the maintenance and the rotation difference of the tire is necessary. A conventional steering wheel mechanism becomes unnecessary by this technology; it is a technology that contributes to reduction in costs and the weight reduction.

The most important problem is the comfortable residence in the vehicle in the case that the structure of the vehicle is made flexible. It is necessary to use flexible materials as interior decoration.

The comfortable flooring which keeps water, dust, wind and temperature is necessary; it corresponds to the change of the floor shape flexibly, and has elasticity as the mat. But the progression of the material is drastically, it is necessary to select the material to fit the structure of the vehicle. The important thing is to select the material which can correspond to the structure of the vehicle flexibly, especially absorb the shock in the case of the accident.

It is a technology that enables the setting of the vehicle center of gravity point in which a free floor configuration and stability exist at the body each position along with a free setting and that of the minimum ground clearance by matching the combination of frames to the change in the angle of the joint and adopting the tire of the small sum diameter.

### BACKGROUND ART

There are a lot of examples of manufacturing by monocoque structure of the passenger car and the bus conventionally. The track and the special vehicle are installation on the frame work of the all-in-one design, and the driving gear was often installed at the same time. However, both monocoque construction and frame work lacked the consideration at the time of the crew and the load getting on and off, the wholesale of the freight, and the load volumes to the operator.

The vehicle including the passenger car has emphases in durability and the great physical strength. Moreover, there were some respects where it lacked consideration for the safety because of being partial to the design, and were a lot of problems as the overall vehicle.

The truck part of the basic structure as the vehicle required a lot of time to achieve the result and to anticipate a large sum of money and goods for the installation, the experiment of the driveline system and the press manufacturing because the design of the substructure that centered on the floor for the passenger car is integral construction. It is required strenuous efforts and time to obtain the goods experiment with good performance.

A large labor for the reduction of shock to the crew was turned on by the crash of the vehicle for securing safety. Since it is not originally a vehicle which was thought by a flexible structural concept of the vehicle, it is difficult to achieve the result of the reduction of body shock to the crew by the effective damage of the anticipated vehicle.

Conventionally, there are examples that the contrived engine, the tire and the driving system of large scale bus are designed not interfere with each other, and the lower-floored truck has 4 axles and uses middle sum diameter tires, and the truck whose carrier part is lower because the rear wheel uses small sum diameter tires. These frames are all-in-one structure, or monocoque structure.

### DISCLOSURE OF THE INVENTION

Problems to be Solved by the Invention

A large labor and the capital were necessary for designing the truck part in the vehicle of a conventional frame type and the monocoque type and the design for body manufacturing division that put above the truck part had the large restriction since it was not flexible each other. For solving the problem, the advantage of a frame work vehicle is looked over again, and frames are divided a lot and connected by the joint. It enables to make the frame type vehicle which can change the angle between the frames and the form of the frames, which makes it possible to design the truck part and body part easily, to cope with the request by the society and change the vehicles quickly. It reduces the all-in-one part structure of the truck part and the part of the large-scale manufacturing such as press manufacturing, and reduces the cost.

Means for Solving Problems

It reviews the goodness of the frame type in the vehicle, makes it the basic of the truck design. The vehicle of the frame form was difficultly inferior an integral stamping of the frame from respect of the cost and weight to the monocoque type, and was difficult correspondence to weight distribution at the truck design, and had the fault that gave strength to the part without the necessity. Therefore, it combines a lot of small frames and connect by the joint to solve the problem. Moreover, it is possible to design freely, prepare the safety design by having the structure which can change the joint angle.

The structure is divided into a necessary part for the engine, the transmission gear supporting section, the driveline system, the axle supporting section, the rear end part, and the part of safety practice etc. and each part is produced according to strength that is necessary respectively, and connect it with the joint that can adjust the angle.

The joint assumes the division type, and uses the motor by the oil pressure or electricity. The angle of joint is controlled by the use of the gear mechanism or the power by the cylinder method or using the oil pressure and air pressure by an electronically controlled technology that the program control is done and control the angle of the joint using the gear structure or the cylinder and the solenoid, etc.

The many small sum diameter tires are used, which can lower the minimum ground clearance, and the idling of the wheel on turning sideways of the vehicle, slipping on the dirt ground or the snow road etc. are decreased sharply. Moreover, the body of the vehicle can be prevented from reaching on the ground by the angle change mechanism using the connection of frames to keep a safe space from the lowest part to the ground, which improving safety.

The tire with each foil is divided and connected with the axle. The connected method cancels the number of an inside and outside tires and uses the actuator oppositely. It uses the differential gear for which it applied by Japanese Patent Application No. 2001-159758 changes the way of the vehicle by changing the number of rotation of the right and left axle by the control device programmed of the each number of rotations.

In the case that the suspension system for which it applied by Japanese Patent Application No. 2001-376608 as a suspension system of each axle is used, it can closely achieve the control of the body further.

The equipment that measures the space to the ground by infrared rays and the millimeter electric waves is set up to each part of the body, it always measure partial each space between ground and vehicles. As a result, the body of the vehicle can be prevented from reaching on the ground.

A free metallic board like a drainboard with free stretch to all directions as the floor of the vehicle is used. It needs the enough stretch in order to correspond to the collision of the vehicles and the change of the form of the entire integrated frames. A thick carpet is used that there are a waterproof property, elastic property, and dust resistance on the floor material. The mat with thin rubber is used between the floor material and the carpet.

At the vehicle crash, the vehicle adjusts the angle for the joint of the frame by the digital signal according to the procedure which is calculated beforehand to expect it and it dents the body. The material and shape are set so that the floor material may follow at that time.

The change for the progress direction is operated by the digital signal, and makes it progress in the direction that the driver intended by controlling the actuator in the front, back, left and right by a steering wheel or a cylinder shape controller.

Effect of the Invention

This invention can achieve the improvement of the customer's satisfaction by the entire externals in which it can simply do an improvement of safety, a great reduction in the improvement of the flexibility of the design of the truck part in the vehicle and the cost, and changes for body manufacturing division.

### BEST MODE TO PUT AN INVENTION INTO PRACTICE

### Embodiment

FIG. 1 shows a concept of connected structure of the angle adjustment type joint of the division type frame. Each frame is connected with the joint by the splicing fitting of the ball terminal type, which forms the integrated frame with a free angle. In the case that the number of frames is increased, freer shape can be achieved, and contributes to the accident and the safety measure.

FIG. 2 shows a concept of the joint. Two arms with rigidity is connected with the gear box by bearing or the pin with durability which has good slide performance, and the arm which has the processed structure with elasticity by the worm gear moved by the rotation of the motor in the box stretches by the program input in the control box in advance and adjust the total length of two arms.

FIG. 3 shows a structural concept of seeing from the upper surface of the division type frame. The main frame, the horizontal beam, and the sub-frame etc. are connected with the joint respectively and constructed as unity. By each being connected with this stick with the joint, degree of freedom of the design of the part body on increases greatly, the destruction of the body is able to be controlled freely at the collision.

FIG. 4 shows the concept of the maintenance and the connection of the tire with the foil with the axle, and the concept of the transmission situation of the driving force with the luggage carrier. To unit with the body (reference letters 12) basically uses the suspension system applying by Japanese Patent Application No. 2001-376608, and to connect between each vehicle uses the differential gear requesting by Japanese Patent Application No. 2001-159758, and adjusts the rotation difference between each wheel and changes the progress direction.

FIG. 5 shows the schematic diagram of the floor material of vehicles. Firstly the plate like a pear in shape pins the plate which can move freely length and width by one or a few pins which can move freely and the length of the pin is extended to correspond to the movement up and down, and the hole is processed to combine the pins with the plate to correspond to the change of the frame freely.

FIG. 6 shows a schematic diagram when the externals frame is operated that the passenger and the crew can easily get on and off for the passenger car. This diagram shows the situation that there is no bump between the entire guest room of the passenger car and the ground. Like this, the technology can achieve in the case the pattern of the usage condition is set and the frame is operated by instructing the microcomputer.

### INDUSTRIAL APPLICABILITY

The frames divided into many parts are connected with the joint which can change the angle, which is assumed the basic structure of the truck. The axle installs the many tires of the division type whose sum diameter is small, increases safety, and attempts the improvement of the load and unload of riding comfort of the crew passenger in the vehicle etc. and freights by the synergy effect of the change of the form of the frame and the small sum diameter tire.

### BRIEF DESCRIPTION OF THE DRAWINGS

FIG. 1 It is a schematic diagram of division type frame.

FIG. 2 It is a schematic diagram of joint.

FIG. 3 It is a schematic diagram of the entire frame work.

FIG. 4 It is a schematic diagram of the division connection of tires.

FIG. 5 It is a schematic diagram of the floor material.

FIG. 6 It is a schematic diagram that shows the change in the seat position for passenger car.

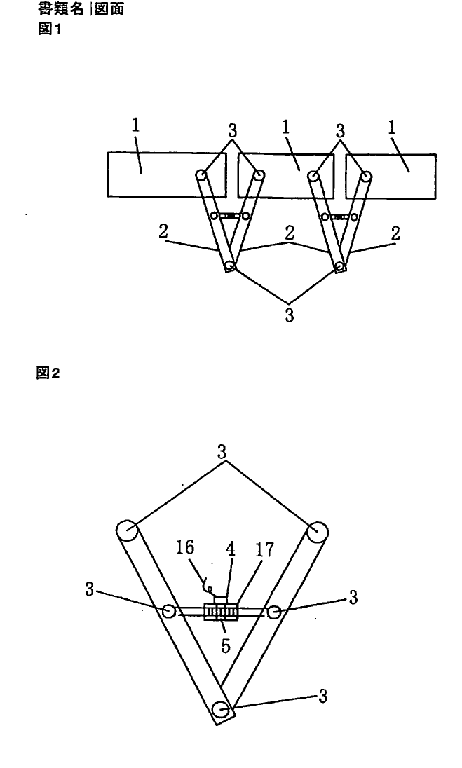

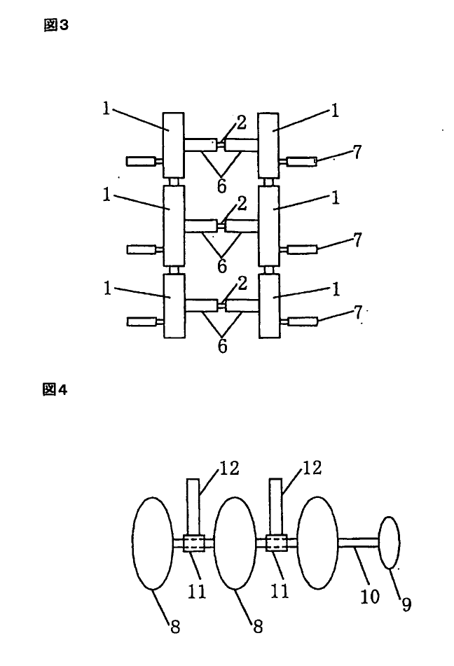

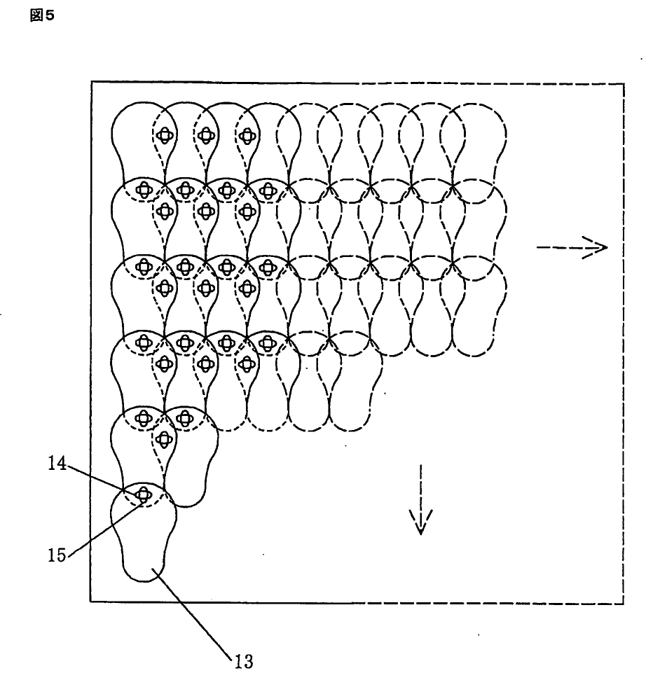

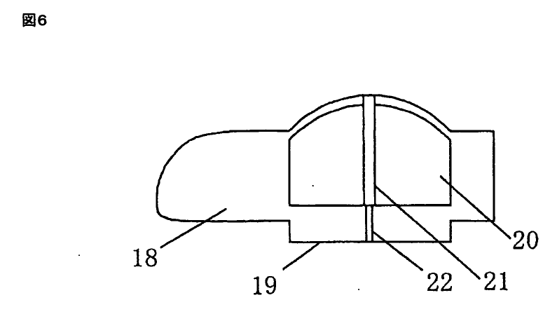

### EXPLANATIONS OF LETTERS OR NUMERALS

1. The division type frame
2. The arm of joints
3. Pole type splicing fitting
4. Motors
5. Gear type adjusting length device
6. Side division type frame
7. Division type sub-frame
8. The tire with foil
9. Carrier
10. Division type axle
11. Differential gear (applying by Japanese Patent Application No. 2001-159758)
12. Suspension system (applying by Japanese Patent Application No. 2001-375508)
13. Division plate for flooring material
14. The foil for fixing by pins
15. The pin for uniting plate
16. The power transmission gear that supplies requirement to No.5
17. The perception sensor for the length
18. The passenger car body
19. The floor for guest room
20. Doors
21. The center pillar
22. The shaft supporting center pillar

1. The structure that divides the frame into more than 2 parts, and connects them with joint, and uses the divided frames as a whole for the body of the vehicles.

2. The structure that can change the angle of the joint which connects the divided frames, and the structure that operates the angle adjustment mechanism by combining gears or directly the hydraulic cylinder oil pressure or the electric motor.

3. The structure that can change the form of the floor in vehicles freely to match the change of the form of frames.

4. The structure of the floor interior material that can match the change of the floor in vehicles and water, dust and air do not enter in vehicles.

5. The mechanism that makes tires' sum diameter small and installs the tire to one shaft, and adjusts difference of the number of rotations between the tires.

6. The structure that adjusts the number of rotations of right and left, front and rear tires and abolishes steering wheel mechanism being used now controls progress direction in vehicle.

7. The structure that has the lowest center of gravity of the body and best ground clearance keeping the clearance from the ground to the structure of the bottom of the body, the bottom of the front and rear body, operating the adjustment of the frames in digital.

8. The structure whose adjustment of frames is made in various patterns and is specified the pattern with the manual by the driver can change the angle of the body and the floor of the body such as the height of the body from the ground for passengers to get on and off most smoothly and It makes the adjustment of the frame various patterns, and the driver specifies the pattern with the manual.

9. The structure that maintains the tire with foil which is installed in each wheel, and operates the tire with foil in case of keeping the progress direction of the vehicle, slipping, the obstacle (dirty ground, stone, and falling object) by the maintenance management.

10. The structure that uses the way of breaking the vehicle effectively at accidents of the head-on collision and the side impact etc. so that makes the body safe for the crew settled with the least shock.
